(19) United States
(12) Patent Application Publication
(10) Pub. No.: US 2014/0274306 A1
(43) Pub. Date: Sep. 18, 2014

(54) SMART PHONE OPTIMATION OF CASHLESS WAGERING

(71) Applicant: James T. Crawford, III, Charlotte, NC (US)

(72) Inventor: James T. Crawford, III, Charlotte, NC (US)

(21) Appl. No.: 13/794,826

(22) Filed: Mar. 12, 2013

(51) Int. Cl. G07F 17/32

(52) U.S. Cl. CPC G07F 17/3244
USPC 463/25

(57) ABSTRACT

A system for transferring credit within a gaming environment includes:
a) A wagering apparatus having an electronic accounting function and a data-providing or transferring function. The providing or transferring function is in communication with the accounting function to enable display of at least available credit identified by the electronic accounting system;
b) A portable data or information capture device that is able to capture data of at least available credit and provide a second transmittable data pack of the at least available credit; and
c) An at least one second wagering apparatus having an information or data capture system capable of capturing the second information transmission of the at least available credit, the second wagering apparatus being in communication with a processor configured to convert the captured data into credit available for wagering or payout in the second wagering apparatus.

### BACKGROUND OF THE INVENTION

1. Field of the Invention

The present invention relates to the field of gaming, management of credit in gaming, and the management of cashless wagering transactions.

2. Background of the Art

There are a wide variety of associated devices that can be connected to a gaming machine such as a slot machine or video poker machine. Some examples of these devices are lights, ticket printers, card readers, speakers, bill validators, ticket readers, coin acceptors, display panels, key pads, coin hoppers and button pads. Many of these devices are built into the gaming machine or components associated with the gaming machine such as a top box which usually sits on top of the gaming machine.

Typically, utilizing a master gaming controller, the gaming machine controls various combinations of devices that allow a player to play a game on the gaming machine and also encourage game play on the gaming machine. For example, a game played on a gaming machine usually requires a player to input money or indicia of credit into the gaming machine, indicate a wager amount, and initiate a game play. These steps require the gaming machine to control input devices, including bill validators and coin acceptors, to accept money into the gaming machine and recognize user inputs from devices, including key pads and button pads, to determine the wager amount and initiate game play. After game play has been initiated, the gaming machine determines a game outcome, presents the game outcome to the player and may dispense an award of some type depending on the outcome of the game.

As technology in the gaming industry progresses, the traditional method of dispensing coins or tokens as awards for winning game outcomes is being supplemented by ticket dispensers which print ticket vouchers that may be exchanged for cash or accepted as credit of indicia in other gaming machines for additional game play. An award ticket system, which allows award ticket vouchers to be dispensed and utilized by other gaming machines, increases the operational efficiency of maintaining a gaming machine and simplifies the player pay out process. An example of an award ticket system is the EZ pay ticket system by International Game Technology of Reno, Nev. Award ticket systems and systems using other cashless mediums are referred to as cashless systems.

Cashless systems, such as the EZ pay ticket system, provide advantages to both game players and casino operators. Cashless systems in which a printed document identifying at least an amount available to the holder of the ticket upon redemption have become desirable in the gaming industry. For example, many players find it more convenient to carry an award ticket than a large number of coins. For gaming machine operators, cashless systems tend to reduce gaming machine operating costs. For example, the infrastructure needed to remove and count indicia of credit (e.g. coins, tokens, bills) from the gaming machine may be eliminated or minimized when it is replaced with a cashless system, which reduces the gaming machine operating costs. Further, coin dust, which is potentially damaging to the components of the gaming machine (e.g. electronic components) may be eliminated or minimized when coin acceptors are replaced with the cashless system. The need for coin changers and wagons with coins are also eliminated.

Currently, cashless systems have become very popular and have been embraced by customers. For example, ticket vouchers that are generated upon cash-out and redeemed for cash or gaming machine credits within a particular casino are well accepted by game players. However, the ticket vouchers are often only redeemable at the casino or the local property where the ticket was generated. Thus, the customer is not allowed to take the ticket voucher generated at one casino property and redeem the ticket voucher at another casino property. The limited redemption capabilities of cashless systems, including ticket vouchers, may be undesirable to an entertainment corporation that owns multiple casino properties. The entertainment corporation may desire that their customers have the ability to take a ticket voucher generated in one property to any of the other properties owned by the entertainment corporation.

Also, multi-site cashless capabilities may be desirable for an area or region such as the Las Vegas strip where a customer could cash out in casino A where a ticket voucher is generated. The customer could then take this ticket down the Las Vegas strip and into casino B where it could be inserted into a gaming machine's bill acceptor and redeemed for credit. In this example, casino A and casino B may or may not be owned by the same entertainment corporation. This type of multi-site validation capability is not possible with current cashless systems. Thus, in view of the above, it would be desirable to provide apparatus and methods for cashless systems that allow a cashless medium, including an award ticket voucher, generated at one site using one type of cashless system to be validated at a second site using the same or a different cashless system.

Additionally, with advancing technology, paper tickets and paper transactions are wasteful and are subject to attempts at fraudulent alteration of tickets or outright forgery of tickets. Even with intrasystem authentication of tickets, the system may be corrupted or manipulated, especially with essentially standard ticket formats on which encryption and information content is standard.

Various ticket-in, ticket-out systems are enabled in U.S. Pat. Nos. 5,470,079; 5,761,647; 6,012,832; 6,048,269; and 6,394,907; and Published U.S. Patent Application Document No. 20100291994 and 20100167811. All cited references are incorporated by reference in their entirety. Near field communication by both visual transfer of information and broadcast (e.g., RF) transmission of data and information has now been technically enabled, especially on portable, hand-held personal communication devices such as smart phones, pads, tablets, PDAs and the like. These personal systems would desirably be incorporated into gaming systems. Hardware and software that enables the use of near filed communication include, by way of non-limiting examples, the technology disclosed in Published U.S. Patent Application Documents Nos. 20130040565; 20130036050; 20130030933; 20130020389; 20130015938; 20130013423; 20120322371; 20120315848; 20120287003; 20120258663; 20120252361; 20120238207; and U.S. Pat. Nos. 8,385,823; 8,381,996; 8,351,857; 8,311,479; 8,265,553; 8,224,246; 8,212,735; 8,190,885; 8,117,445; 8,014,722; 7,970,350; and 7,899,393 enables near field communication (NFC), components enabling NFC, security systems and methods for NFC and value transfer systems using NFC to enable such NFC value transfer.

### SUMMARY OF THE INVENTION

A system is enabled for transferring credit within a gaming environment may include, by way of non-limiting examples:
a) A wagering apparatus having an electronic accounting function and an information-providing function, the information-providing function in communication with the accounting function to enable external transmission of at a first least available credit identified by the electronic accounting system.
b) A portable information capture device that is able to capture the first externally transmitted information of at least available credit in a digital electronic format or digital or analog visual information and store the captured externally transmitted information of at least available credit in a digital electronic format;
c) The portable information capture device being capable of externally transmitting stored of at least available credit in a digital electronic format to provide a second transmission of the at least available credit; and
d) An at least one second wagering apparatus or a terminal directly providing currency upon demand having an information capture system capable of capturing the second transmitted information of the at least available credit, the at least one second wagering apparatus in communication with a processor configured to convert the captured second viewable display into credit available for wagering in the at least one second wagering apparatus or payout from the terminal directly providing currency.

### BRIEF DESCRIPTION OF THE FIGURES

FIG. 1 is a schematic of a generic system for practicing near field visual or RF communication in a gaming environment.

FIG. 2 is a schematic of a near field portable system for practicing near field visual or RF communication in a gaming environment.

### DETAILED DESCRIPTION OF THE INVENTION

A system is enabled for transferring credit within a gaming environment may include, by way of non-limiting examples:
a) A wagering apparatus having an electronic accounting function and an information-providing function, the information-providing function in communication with the accounting function to enable external transmission of at a first least available credit identified by the electronic accounting system.
b) A portable information capture device that is able to capture the first externally transmitted information of at least available credit in a digital electronic format or digital or analog visual information and store the captured externally transmitted information of at least available credit in a digital electronic format;
c) The portable information capture device being capable of externally transmitting stored of at least available credit in a digital electronic format to provide a second transmission of the at least available credit; and
d) An at least one second wagering apparatus or a terminal directly providing currency upon demand having an information capture system capable of capturing the second transmitted information of the at least available credit, the at least one second wagering apparatus in communication with a processor configured to convert the captured second viewable display into credit available for wagering in the at least one second wagering apparatus or payout from the terminal directly providing currency.

The generic system of the present technology may include specific formatted systems for specific modes of communication, including visual transmission of information, visual transmission of information, even audio transmission of information, initial transmissions in analog format and storage and subsequent transmission in digital form, or initial and subsequently transmission in digital format.

Such system may be alternatively described as, by way of non-limiting examples,

One available system for transferring credit within a gaming environment may include a video transmission and video capture system having:
a) A wagering apparatus having an electronic accounting function and an image-providing function. The image-providing function is in communication with the accounting function to enable display of at least available credit identified by the electronic accounting system. The display may be as an analog image or a digital image or a combination of the two. Mobile tagging may also be used in a process by which is the process of providing data read from tags for display on mobile devices, commonly encoded in a two-dimensional barcode, using the camera of a camera phone as the reader device. The contents of the tag code is usually a URL for information addressed. Currently about 70 different types of barcodes and their specific versions exist and are mostly in use in the field of logistics. In terms of mobile tagging, the number of codes is essentially restricted to a dozen types. For reading out 2d-barcodes it is essential to install specific software, a reader, on the mobile device. The reader uses the camera of a mobile phone for the mobile tagging process. The producers of the reader are very involved in developing solutions to increase the number of compatible mobile phones. Most services on the corresponding websites offer the download directly onto the mobile device or PC. In addition, many providers offer the user a generator for creating their own codes. Smartphone cameras can be used in Google's mobile Android operating system via both their own Google Goggles application or 3rd party mobile tag readers like Scan. Various codes such as QR-Code, DataMatrix, Cool-Data-matrix, Aztec, Upcode, TrillCode, Quickmark, Shotcode, Mcode, Bee tag and Microsoft Tag, are non-limiting examples of the types of scannable, image-capture data sources that can be used, along with standard bar code images.
b) A portable image capture device that is able to capture the display of at least available credit in a digital electronic format and provide a second viewable display of the at least available credit. These may be standard image=-capture devices or components found on smart phones and cell phones and pads and tablets commercially available on the market and used in commerce.
c) An at least one second wagering apparatus or payout terminal (that dispenses cash, currency and/or coins and tokens) having an image capture system capable of capturing the second viewable display of the at least available credit, the at least one second wagering apparatus or payout terminal in communication with a processor configured to convert the captured second viewable display into credit available for wagering in the at least one second wagering apparatus or for being paid out at the \payout terminal.

Another description of an alternative system for use within the scope of the present invention may include a system for transferring credit within a gaming environment using:
a) A wagering apparatus having an electronic accounting function and an information-providing function, the information-providing function in communication with the accounting function to enable external transmission of at a first least available credit identified by the electronic accounting system;
b) A portable information capture device that is able to capture the first externally transmitted information of at least available credit in a digital electronic format and store the captured externally transmitted of at least available credit in a digital electronic format;
c) The portable information capture device being capable of externally transmitting stored of at least available credit in a digital electronic format to provide a second transmission of the at least available credit; and
d) An at least one second wagering apparatus having an information capture system capable of capturing the second transmitted information of the at least available credit, the at least one second wagering apparatus in communication with a processor configured to convert the captured second viewable display into credit available for wagering in the at least one second wagering apparatus.

The transmission may be near field communication by any electromagnetic system used in communication, such as light transmission and RF transmission, and may even include audio transmission as a less preferred embodiment, along or in combination with each other.

Another further description of an alternative system for use within the scope of the present invention may include a system for transferring credit within a gaming environment using:
a) A wagering apparatus having an electronic accounting function and an information-providing function, the information-providing function in communication with the accounting function to enable external transmission of at a first least available credit identified by the electronic accounting system;
b) A portable information capture device that is able to capture the first externally transmitted information of at least available credit in a digital electronic format and store the captured externally transmitted of at least available credit in a digital electronic format;
c) The portable information capture device being capable of externally transmitting stored of at least available credit in a digital electronic format to provide a second transmission of the at least available credit; and
d) An at least payout system capable of storing and providing at least currency and having an information capture system capable of capturing the second transmitted information of the at least available credit, the at least one second wagering apparatus in communication with a processor configured to convert the captured second transmitted information into credit available for payout wagering in the at least one second wagering apparatus.

This method also could be implemented using the existing TITO technology by having a Imaging/Scanning device to connect into an existing ticket printer and instead of printing a ticket it would display an image of the ticket, securely so that it would not be visible to general public or even the person using the device. This device would also be able to read the ticket via scan or camera capture (or other non wireless methods) to identify and validate the ticket. The provided information, rather than being displayed on a video screen on the gaming apparatus, could be a unique or standard TITO ticket presently provided in the gaming industry. Once a ticket has been exhausted and reported through the accounting system, usually to a central processor, attempts to reuse the recorded payout data on a duplicate ticket or another electronic ticket will be identified and refused. In this manner, the TITO information may be carried not only from machine to machine but also from casino to casino easily.

The smart device or cell phone camera would then capture the image to safely transfer the ticket to another similar device on another gaming machine and therefore replacing the need for using a physical ticket all together. It could be possible to use an application designed specifically for this purpose for use on a cell phone or smart device that could capture and store the image for later use. These are usually called I Phone or Android Apps.

This method could be implemented using new technology (an imaging and ticket reading device) that would integrate into some or all of the existing TITO technology already developed and installed in thousands of machines around the world. It would be an Imaging/ticket reading device to connect into an existing SAS backend system and instead of printing a ticket it would display an image of the ticket, securely so that it would not be visible to general public or even the person using the device. (SAS is an integrated system of software that enables you to do everything from accessing data across multiple sources to performing sophisticated analyses and delivering information across the organization as needed. SAS foundation products are available as individual software modules, and they serve as the foundation for SAS solutions.)

The smart device or cell phone camera would then be placed in such a way as to securely capture the image to safely transfer the ticket to another similar device on another gaming machine and therefore replacing the need for using a physical ticket all together. It could be possible to use an application designed specifically for this purpose for download and use on a cell phone or smart device that could manage, capture and store the images for later use. And, or delete or mark the tickets as used after transfer into another gaming device.

Conventional TITO systems, with existing formats of TITO printing can be used within the practice of the present technology, incorporated with the present system, or be modified to enhance their performance within the practice of the present invention. For example, the TITO printed receipt is already registered within a casino processor-based system so that when the ticket is entered into an ATM-type ticket return device, the bar code or other imagery on the ticket is scanned and then compared to information stored within the casino system to authenticate the ticket, verify the amount to be paid, and then pay out the verified amount from the machine.

In the practice of the present invention, the hand-held scanning or camera device will capture the image of the ticket, and especially the bar code, store the image in the hand held device, and then display that image to a second gaming system or pay out terminal/ATM-device (which will have its own image reading capacity or near filed communication system accessible from the hand-held device). The image content, by image display or electronic data transfer (e.g., near field communication, or insertion of the device to engage an I/O port, or connection through a cable or connector to electronically transfer information) will transfer the image information to the machine (gaming machine or pay out machine, or at the cashier's window) and either wagering amounts will become available or cash out from the machine or window will become available.

The ability to use existing TITO ticket systems provided in today's gaming systems is an advantage as then only the hand-held devices need be changed, or an image-receiving/information receiving device can be added to existing gaming systems, minimizing hardware costs to the casino. Existing machines may be retrofit or new machines with these capabilities can be built.

These new information transfer systems through hand-held devices can be configured to communicate with existing accounting functions in ther machines and casinos. Therefore, when the information/image is transferred from the hand-held device, that information would be transmitted to the accounting function processor/server, the code validated, the amount verified and the funds made available for use in wagering, addition to an existing account, opening a new account or being paid out to the holder of the hand-held device.

The simplest mode of operation of this system with existing TITOP printed information would be along the lines of the following steps. A standard TITO ticket is printed out by a gaming device. The player scans or takes a direct picture of the ticket and stores the information (either on the hand-held device or in a distal server). The player then carries the hand-held device to another machine (with or without the ticket, which may now be destroyed). The player then transfers the information to the new machine (or returns to the old machine after a break) and the new machine transfers the information regarding the ticket content through the accounting function to verify the information transferred, validate the amount indicated in the information, and then applies that value according to the functionality of the new machine.

The system may be integrated with not only pure electronic gaming machines and slot-type machines, but may also be integrated for use with gaming tables, with one or more terminals at gaming tables being able to read the information from the hand-held device, or the hand-held device may be passed to a croupier who then transfers the information into the system and then returns the hand-held device to the player.

The term “transmit” as used herein includes physical transmission, direct recording of image transfer, as well as transfer of data by electronic transfer. The term therefore includes taking a picture of a physical (printed) image, taking a picture of an electronically displayed image, scanning of a a physical (e.g., printed) image, wireless transfer of data, wire communication of data, and the like. Unless specifically and further limited, the broad meaning should be inferred by the term.

The smart device or cell phone camera could also display information that would allow the imagining/scanning device to identify the customer for player tracking or account backup.

This implementation is more secure than wireless communication and is a physical transfer (albeit electronic) of information that belongs to the patron.

The system may have varied functional capabilities. The image-providing function comprises a printer that prints out a ticket on a substrate, and for example a bar code on the ticket is read, and information regarding the bar code is stored in a server distal from the wagering apparatus. The at least one second wagering apparatus is in communication with the distal server and the distal server is configured to be able to communicate information relating to the bar code to the at least one second wagering system. The image-providing function may comprise a display screen on the wagering apparatus or a near field communication system on the wagering apparatus.

FIG. 1 shows a sketch of a generic system for practicing near field visual or RF communication in a gaming environment. A top box 100 having a frame 180 with a large display screen 1410 is shown. The top box 100 is attached to a gaming device (not shown) bu stem support 106. An image of a ticker 102 is shown on the screen 1410, and a physical ticket 104 corresponding to the image of the ticket 102 is also shown. One or more of these tickets may be available to a player for use. A hand-held device 600 is shown for either taking a camera shot of the ticket image 102, a camera shot of the physical ticket 104, a scan of the bar code 110, or a near field transmission of data (shown by an indication of a flash transmission 180) to the hand-held device 600 from the top box 100. Movement of the hand-held device 600 from position A to position B is shown (120).

This type of system shown in FIG. 1 may be built into the gaming apparatus or become an add-on to an existing gaming system. Only one or multiple means of communication may be provided by the add-on or built-in system. An APP may be transferable and downloadable to each type of hand-held device for free when entering a casino environment. The player with the hand-held device may have the option or be required to provide additional information into the casino system, such as a call number, phone number, e-mail address, room number, player card number, credit card number, debit card number, smart card number or other personal identification as both a security aid or as information the casino would like to use for later contact with the player. Comps may also be coordinated through the use of this system, with the winnings, losses, play-time, wagering amounts and the like retained in memory by a casino central server with accounting functions. Casinos may also provide hand-held devices for use by the individual players, with security tags or chips preferably embedded in the loaned hand-held devices to assure that they can be tracked to prevent removal from control by the casino. As previously noted, these hand-held devices could be dedicated devices, conventional smart phones, cell phones, pads, tablets, and the like, most of which now contain at least camera functionality and could contain NFC (near field communication) technology, scanning capability, and capability for converting analog data into digital data for transmission.

FIG. 2 is a block diagram from Published U.S. Patent Application Document 2013/0044051 which has been modified to apply more directly to use in near field communication within the field of the present technology and invention. FIG. 2 is a block diagram of an image display device according to an embodiment of the present invention.

As shown in FIG. 2, the image display device 100 according to an embodiment of the present invention may include a broadcast receiving unit 105, an external device interface unit 130, a storage unit 140 (e.g., memory), a user input interface unit 150, a sensor unit (not shown), a controller 170, a display 180, an audio output unit 185, and an optional remote control device 200.

The broadcast receiving unit 105 may include a tuner unit 110 (which may be fixed and preset to communication on specific wavelengths for use with the equipment in electronic near field communication), a demodulator 120, and a network interface unit 135. Of course, the broadcast receiving unit 105 may be designed such that the broadcast receiving unit 105 includes the tuner unit 110 and the demodulator 120 and does not include the network interface unit 135 and may also be designed such that the broadcast receiving unit 105 includes the network interface unit 135 and does not include the tuner unit 110 and the demodulator 120.

The tuner unit 110 selects or is preprogrammed on an RF broadcast signal corresponding to a channel selected by the casino or corresponding to various stored channels from among Radio Frequency (RF) broadcast signals received through an antenna. In addition, the tuner unit 110 converts the selected RF broadcast signal into an intermediate frequency signal or a baseband image or less preferably an audio signal.

For example, the tuner unit 110 converts the selected RF broadcast signal into a digital IF signal (DIF) when the selected RF broadcast signal is a digital broadcast signal and may convert the selected RF broadcast signal into an analog baseband image or audio signal (CVBS/SIF) when the selected RF broadcast signal is a less preferred analog broadcast signal. That is, the tuner unit 110 may process a digital broadcast signal or an analog broadcast signal. The analog baseband image or audio signal (CVBS/SIF) output from the tuner unit 110 may be directly input to the controller 170.

The tuner unit 110 may receive an RF broadcast signal of a single carrier according to an Advanced Television System Committee (ATSC) scheme or RF broadcast signals of multiple carriers according to a Digital Video Broadcasting (DVB) scheme.

The tuner unit 110 may sequentially select RF broadcast signals of all broadcast channels stored through a channel storage function from among RF broadcast signals received through an antenna and then convert the selected RF broadcast signals into an intermediate frequency signal or a baseband image or audio signal.

The tuner unit 110 may also include a plurality of tuners to receive broadcast signals of a plurality of channels, each dedicated to a different system with which the tuner communicates, such as different classes of gaming devices, different casino devices, different cash retrieval terminals, ATMs and the like. The tuner unit 110 may also include a single tuner to simultaneously receive broadcast signals of a plurality of channels.

The demodulator 120 receives the digital IF signal (DIF) produced through conversion by the tuner unit 110 and performs a demodulation operation on the digital IF signal.

The demodulator 120 may output a stream signal (TS) after performing demodulation and channel decoding. Here, the stream signal may be a signal in which a video signal, an audio signal, or a data signal are multiplexed. The audio signal may be used for visually impaired users to accommodate them, with the audio signal being a broadcast the impaired user can appreciate.

The stream signal output from the demodulator 120 may be input to the controller 170. The controller 170 outputs video to the display 180 and outputs audio to the audio output unit 185 after performing demultiplexing, image/audio signal processing, and the like.

The external device interface unit 130 may transmit or receive data to or from an external device connected to the external device interface unit 130. To accomplish this, the external device interface unit 130 may include an A/V input/output unit (not shown) or a wireless communication unit (not shown).

The A/V input/output unit (not shown) may receive video and audio signals from the external device. The wireless communication unit (not shown) may perform local area wireless communication with another electronic device.

The network interface unit 135 provides an interface for connecting the image display device 100 to a wired/wireless network including the Internet. For example, the network interface unit 135 may receive content or data provided by an Internet or content provider or a network operator.

The network interface unit 135 may perform data communication with an electronic device adjacent to the image display device 100. Here, the network interface unit 135 may also receive device information of another electronic device, remote-controllable channel information, frequency information, or code information of another electronic device, or the like.

The storage unit 140 may store programs for all signal processing and control of the controller 170 and may also store signal-processed video, audio, or data signals.

The storage unit 140 may perform a function to temporarily store video, audio, or data signals input to the external device interface unit 130. The storage unit 140 may also store information regarding broadcast channels through a channel storage function such as a channel map function.

Although the storage unit 140 may be provided separately from the controller 170 in the embodiment illustrated in FIG. 2, the present invention is not limited to this embodiment. For example, the storage unit 140 may be included in the controller 170.

The user input interface unit 150 may deliver a signal input by the user to the controller 170 or may deliver a signal from the controller 170 to the user.

For example, the user input interface unit 150 may receive a user input signal for power on/off game selection on gaming systems enabling play of multiple games (separately or contemporaneously), screen setting, or the like from the remote control device 200, deliver a user input signal received from a local key (not shown) such as a power key, a channel key, a volume key, or a setting key to the controller 170, deliver a user input signal received from a sensor unit (not shown) that senses user gesture to the controller 170, or transmit a signal from the controller 170 to the sensor unit (not shown).

According to an embodiment of the present invention, the user input interface unit 150 may receive personal information from the remote control device 200. The user input interface unit 150 may receive information of a web server, which is currently connected through personal information, in addition to the personal information. For example, when the mobile terminal 600 and the remote control device 200 have approached each other within a predetermined distance to perform NFC, the remote control device 200 may receive personal information stored in the mobile terminal 600. The remote control device 200 may transmit personal information to the image display device 100 according to an IR or RF scheme. Here, the user input interface unit 150 delivers the received personal information to the controller 170.

On the other hand, the personal information may include personal ID information, password information, personal email information, or the like of the mobile terminal 600. The personal information may also include personal ID information, password information, personal email information, or the like of the image display device 100. The personal information may be personal ID information or password information that can be commonly used in various electronic devices including the mobile terminal 600. The personal information may also be personal ID information, password information, or the like for a web server that is previously stored in the mobile terminal 600. The personal information may also be personal ID information, password information, or the like for a web server which can be used not only in the mobile terminal 600 but also in the image display device 100. The personal information may also be personal ID information, password information, or the like for a web server connected to the image display device 100.

On the other hand, the user input interface unit 150 may also receive, from the remote control device 200, device information of another electronic device, remote-controllable channel information, frequency information, or code information of another electronic device, or the like transmitted from any electronic device adjacent to the image display device 100.

The controller 170 may demultiplex an input stream through the image display device 100, the demodulator 120, or the external device interface unit 130, process the demultiplexed signals, and generate and output signals for video or audio output.

The video signal which has been image-processed by the controller 170 may be input to the display 180 and an image corresponding to the video signal may then be displayed on the display 180. The video signal which has been image-processed by the controller 170 may also be input to an external output device through the external device interface unit 130.

Although not shown in FIG. 2, the controller 170 may include a demultiplexer, an image processor, or the like.

Although specific devices, technology and systems have been identified, these specific examples are to be considered as examples within the generic scope of the invention, and even where identified as preferred are not intended to directly or indirectly limit the scope of claims unless those specific embodiments and examples are included specifically in the claim language.

What is claimed:

1. A system for transferring credit within a gaming environment comprising:
a) A wagering apparatus having an electronic accounting function and an image-providing function, the image-providing function in communication with the accounting function to enable display of at least available credit identified by the electronic accounting system;
b) A portable image capture device that is able to capture the display of at least available credit in a digital electronic format and provide transmittable data of the at least available credit; and
c) An at least one second wagering apparatus or payout terminal having a data capture system capable of capturing the transmittable data of the at least available credit, the at least one second wagering apparatus or payout terminal in communication with a processor configured to convert the transmittable data into credit available for wagering in the at least one second wagering apparatus or payment from the payout terminal.

2. The system of claim 1 wherein the image-providing function comprises a printer that prints out a ticket on a substrate.

3. The system of claim 2 wherein a bar code on the ticket is imaged or read, and information from the bar code is stored in a server distal from the wagering apparatus.

4. The system of claim 3 wherein the at least one second wagering apparatus is in communication with the distal server and the distal server is configured to be able to communicate information relating to the bar code to the at least one second wagering system.

5. The system of claim 1 wherein the image-providing function comprises a display screen on the wagering apparatus.

6. The system of claim 1 wherein the image-providing function comprises a near field communication system on the wagering apparatus.

7. A system for transferring credit within a gaming environment comprising:
a) A wagering apparatus having an electronic accounting function and an information-providing function, the information-providing function in communication with the accounting function to enable external transmission of at least a first available credit identified by the electronic accounting system;
b) A portable information capture device that is able to capture the first externally transmitted information of the at least available credit in a digital electronic format and store the captured externally transmitted of the at least available credit in a digital electronic format;
c) The portable information capture device being capable of externally transmitting stored information of at least available credit in a digital electronic format to provide a second transmission of the at least available credit; and
d) An at least one second wagering apparatus or value payout device having an information capture system capable of capturing the second transmitted information of the at least available credit, the at least one second wagering apparatus or value payout device being in communication with a processor configured to convert the captured second viewable display into credit available for wagering or payout in the at least one second wagering apparatus or value payout device.

8. The system of claim 7 wherein the image-providing function comprises a printer that prints out a ticket on a substrate.

9. The system of claim 8 wherein a bar code on the ticket is read and information regarding the bar code is stored in a server distal from the wagering apparatus.

10. The system of claim 9 wherein the at least one second wagering apparatus is in communication with the distal server and the distal server is configured to be able to communicate information relating to the bar code to the at least one second wagering system.

11. The system of claim 7 wherein the image-providing function comprises a display screen on the wagering apparatus.

12. The system of claim 7 wherein the image-providing function comprises a near field communication system on the wagering apparatus.

13. A system for transferring credit within a gaming environment comprising:
a) A wagering apparatus having an electronic accounting function and an information-providing function, the information-providing function in communication with the accounting function to enable external transmission of at least a first least available credit identified by the electronic accounting system;
b) A portable information capture device that is able to capture the first externally transmitted information of at least available credit in a digital electronic format and store the captured externally transmitted of at least available credit in a digital electronic format;
c) The portable information capture device being capable of externally transmitting stored information of the at least available credit in a digital electronic format to provide a second transmission of the at least available credit; and
d) An at least payout system capable of storing and providing at least currency and having an information capture system capable of capturing the second transmitted information of the at least available credit, the at least one second wagering apparatus in communication with a processor configured to convert the captured second transmitted information into credit available for payout wagering in the at least one second wagering apparatus.

14. The system of claim 13 wherein the image-providing function comprises a printer that prints out a ticket on a substrate.

15. The system of claim 14 wherein a bar code on the ticket is read, and information regarding the bar code is stored in a server distal from the wagering apparatus.

16. The system of claim 15 wherein the at least one second wagering apparatus is in communication with the distal server and the distal server is configured to be able to communicate information relating to the bar code to the at least one second wagering system.

17. The system of claim 13 wherein the image-providing function comprises a display screen on the wagering apparatus.

18. The system of claim 13 wherein the image-providing function comprises a near field communication system on the wagering apparatus.
